(19) United States
(12) Patent Application Publication
(10) Pub. No.: US 2026/0039781 A1
(43) Pub. Date: Feb. 5, 2026

(54) DISPLAY IMAGE GENERATION APPARATUS AND IMAGE DISPLAY METHOD

(71) Applicant: Sony Interactive Entertainment Inc., Tokyo (JP)

(72) Inventor: Ryotaro Yada, Tokyo (JP)

(73) Assignee: Sony Interactive Entertainment Inc., Tokyo (JP)

(21) Appl. No.: 19/267,362

(22) Filed: Jul. 11, 2025

(30) Foreign Application Priority Data
Jul. 30, 2024 (JP) 2024-123461

(51) Int. Cl. H04N 13/293; H04N 13/111; H04N 13/344; H04N 13/361

(52) U.S. Cl. CPC H04N 13/293; H04N 13/111; H04N 13/344; H04N 13/361

(57) ABSTRACT

Provided is a display image generation apparatus including a captured image acquisition section that acquires data of an image captured by a camera, an object arrangement section that arranges a virtual object to be operated by a user in a virtual three-dimensional space, a display image generation section that generates a display image by drawing an image of the virtual object and synthesizing the image of the virtual object with the captured image, and an output section that outputs data of the display image. The display image generation section switches whether or not to use an intermediate image representing the image of the virtual object from a viewpoint of the camera when drawing the image of the virtual object, according to a state of a display world including the virtual object.

### CROSS REFERENCE TO RELATED APPLICATIONS

This application claims priority to Japanese Patent Application JP 2024-123461 filed Jul. 30, 2024, the entire contents of which are incorporated herein by reference.

### BACKGROUND

The present disclosure relates to a display image generation apparatus and an image display method by which a captured image and computer graphics (CG) are synthesized and displayed.

An image display system in which a target space can be appreciated from a free viewpoint has become popular. For example, there has been developed a system that displays a panoramic video on a head-mounted display in such a manner as to display an image corresponding to a line of sight of a user wearing the head-mounted display. By displaying stereo images with parallax for the left eye and the right eye on the head-mounted display, the displayed images appear three-dimensional to the user, and a sense of immersion to the image world can be enhanced.

In addition, there has been put into practical use a technique for realizing augmented reality (AR) or mixed reality (MR) by using a head-mounted display provided with a camera that captures an image of a real space and synthesizing CG with the captured image. The captured image is also displayed on a hermetic head-mounted display, which is useful when a user checks his or her surroundings or sets a play area of a game.

### SUMMARY

In the technique for synthesizing CG of a virtual object with a captured image, such as AR and MR, the accuracy of alignment between an image of a real object and CG greatly influences the quality of content. However, it is not easy to precisely align the captured image, which is originally two-dimensional information, with a virtual object that has three-dimensional information. In particular, in a situation where the display field of view may largely change depending on the movement of a user, it is necessary to perform synthesizing so as to follow the change, and it becomes more difficult to perform precise alignment.

In addition, regardless of whether or not the captured image is to be synthesized, in a mode where a user operates a virtual object to designate an object in the display world or generate interaction therewith, if the positional relation set in a three-dimensional space is not accurately expressed, the user may fail to perform an intended operation or may feel uncomfortable. This problem tends to become more apparent as the types and specifications of virtual objects included in a display are more diversified.

The present disclosure has been made in view of such problems, and it is desirable to provide a technique for highly accurately synthesizing CG and a captured image with a small load. It is also desirable to provide a technique that allows a user to appropriately perform an operation on a display world by using a virtual object regardless of the situation.

According to an aspect of the present disclosure, there is provided a display image generation apparatus. The display image generation apparatus includes a captured image acquisition section that acquires data of an image captured by a camera, an object arrangement section that arranges a virtual object to be operated by a user in a virtual three-dimensional space, a display image generation section that generates a display image by drawing an image of the virtual object and synthesizing the image of the virtual object with the captured image, and an output section that outputs data of the display image. The display image generation section switches whether or not to use an intermediate image representing the image of the virtual object from a viewpoint of the camera when drawing the image of the virtual object, according to a state of a display world including the virtual object.

According to another aspect of the present disclosure, there is provided an image display method. The image display method includes acquiring data of an image captured by a camera, arranging a virtual object to be operated by a user in a virtual three-dimensional space, generating a display image by drawing an image of the virtual object and synthesizing the image of the virtual object with the captured image, and outputting data of the display image. The generating the display image switches whether or not to use an intermediate image representing the image of the virtual object from a viewpoint of the camera when drawing the image of the virtual object, according to a state of a display world including the virtual object.

It should be noted that any combination of the above-described constituent elements and expressions of the present disclosure converted between methods, apparatuses, systems, computer programs, data structures, recording media, and the like are also effective as aspects of the present disclosure.

According to the aspects of the present disclosure, it is possible to synthesize CG and a captured image highly accurately with a small load. In addition, a user can easily perform an operation on a three-dimensional display world.

### BRIEF DESCRIPTION OF THE DRAWINGS

FIG. 1 is a diagram for depicting a configuration example of an information processing system according to an embodiment of the present disclosure;

FIG. 2 is a diagram for depicting an example of the appearance shape of a head-mounted display according to the present embodiment;

FIG. 3 is a diagram for depicting functional blocks of the head-mounted display according to the present embodiment;

FIGS. 4A and 4B are diagrams for depicting examples of the appearance shapes of input devices according to the present embodiment;

FIG. 5 is a diagram for depicting functional blocks of the input device according to the present embodiment;

FIG. 6 is a diagram for explaining the relation between a three-dimensional space forming a display world of the head-mounted display and a display image generated from a captured image in the present embodiment;

FIG. 7 is a diagram for explaining the difference from the real world that can occur in a see-through image in the present embodiment;

FIG. 8 is a diagram for explaining the principle of occurrence of a positional deviation when CG is synthesized with the see-through image in the present embodiment;

FIG. 9 is a diagram for explaining a method of aligning CG with an image of a real object in the present embodiment;

FIG. 10 is a diagram for exemplifying a mode in which a user interacts with the display world via a virtual object in the present embodiment;

FIG. 11 is a diagram for schematically depicting an example of an image to be displayed on the head-mounted display when the user sets a play area by a designation object in the present embodiment;

FIG. 12 is a diagram for schematically depicting an example of a display image including an object for which an intermediate image is not allowed to be generated in the present embodiment;

FIG. 13 is a diagram for schematically depicting an example of a display image including an object for which an intermediate image is not allowed to be generated in the present embodiment;

FIG. 14 is a diagram for depicting an example of setting whether or not to use an intermediate image when an information processing apparatus draws a virtual object in the present embodiment;

FIG. 15 is a diagram for depicting an internal circuit configuration of the information processing apparatus according to the present embodiment;

FIG. 16 is a diagram for depicting a configuration of functional blocks of the information processing apparatus according to the present embodiment; and

FIG. 17 is a flowchart for depicting a processing procedure for generating a see-through image with which CG of a virtual object can be synthesized, by the information processing apparatus according to the present embodiment.

### DETAILED DESCRIPTION OF THE PREFERRED EMBODIMENT

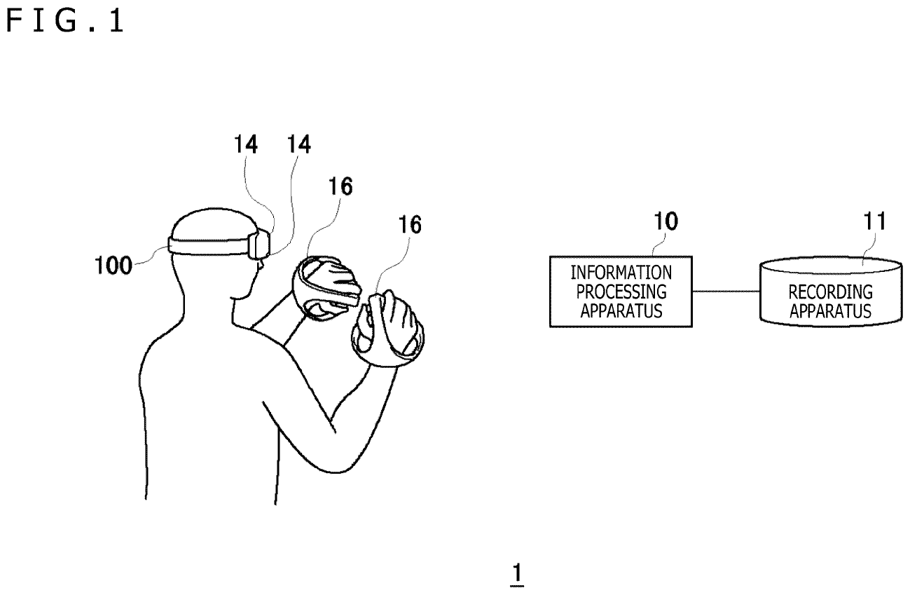

FIG. 1 depicts a configuration example of an information processing system 1 according to an embodiment of the present disclosure. The information processing system 1 includes an information processing apparatus 10, a recording apparatus 11, a head-mounted display 100, and input devices 16. The recording apparatus 11 records system software to be used for information processing by the information processing apparatus 10 and applications such as content software.

The information processing apparatus 10 loads the software stored in the recording apparatus 11 and processes the content to generate a display image. Typically, the information processing apparatus 10 specifies, on the basis of the position and posture of the head of a user wearing the head-mounted display 100, the position of the viewpoint and the line of sight of the user and generates a display image with the corresponding field of view. For example, the information processing apparatus 10 realizes virtual reality (VR) by generating an image representing a virtual world that is the stage of a game while advancing the electronic game.

However, the type and purpose of the content processed by the information processing apparatus 10 in the present embodiment are not particularly limited. The information processing apparatus 10 may be connected to a server via a network, which is not illustrated, and acquire software of content, data of an image to be displayed, or the like from the server. The information processing apparatus 10 may be connected to the head-mounted display 100 and the input devices 16 by a known wireless communication protocol or may be connected thereto by a cable.

The head-mounted display 100 is a display apparatus that has a display panel located in front of the eyes of the user when the head-mounted display 100 is worn on the head of the user, and that displays an image on the display panel. The head-mounted display 100 displays an image for the left eye on a left-eye display panel and an image for the right eye on a right-eye display panel. Stereoscopic vision can be realized by displaying images having parallax as the images for the left eye and the right eye. The head-mounted display 100 is also provided with an eyepiece lens for enlarging the viewing angle. The information processing apparatus 10 generates data of a parallax image that is subjected to reverse correction so as to eliminate optical distortion caused by the eyepiece lens, and transmits the data to the head-mounted display 100.

The head-mounted display 100 is mounted with a plurality of imaging apparatuses 14. The plurality of imaging apparatuses 14 are attached to different positions on the front surface of the head-mounted display 100 in different postures such that, for example, the total imaging range obtained by adding the respective imaging ranges of the imaging apparatuses 14 covers the field of view of the user. The plurality of imaging apparatuses 14 capture images of a real space at a predetermined cycle (e.g., 120 frames per second) at a synchronized timing. The head-mounted display 100 sequentially transmits data of the captured images to the information processing apparatus 10.

The head-mounted display 100 is also provided with an inertial measurement unit (IMU) including a three-axis acceleration sensor and a three-axis angular velocity sensor. The head-mounted display 100 transmits sensor data to the information processing apparatus 10 at a predetermined cycle (e.g., 800 Hz).

The input device 16 is provided with a plurality of operating members such as operation buttons, and the user operates the operating members with his or her hand and fingers while gripping the input device 16. When the information processing apparatus 10 executes a game, the input device 16 is used as a game controller. The input device 16 is provided with an IMU including a three-axis acceleration sensor and a three-axis angular velocity sensor and transmits sensor data to the information processing apparatus 10 at a predetermined cycle (e.g., 800 Hz).

In the present embodiment, not only information regarding operations performed on the operating members of the input device 16 but also the position, speed, and posture of the input device 16 are handled as operation information, for example, and are reflected in the movement or the like of a virtual object in the display world. For example, the information processing apparatus 10 represents CG of a laser beam of a laser pointer as if the laser beam is emitted from the input device 16, and changes the position and posture of the laser beam so as to be linked with the position and posture of the input device 16. Accordingly, the user can point to an object or an area in the display world with a feeling similar to the operation of the actual laser pointer.

In order to track the position and posture of the input device 16, the input device 16 may be provided with a plurality of markers that can be imaged by the imaging apparatuses 14 of the head-mounted display 100. The information processing apparatus 10 may have a function of analyzing the captured images of the input device 16 to estimate the position and posture of the input device 16 in the real space.

The information processing apparatus 10 may also have a function of analyzing the sensor data transmitted from the input device 16 to estimate the position and posture of the input device 16. In this case, the information processing apparatus 10 may derive the position and posture of the input device 16 by integrating the estimation result based on the marker images and the estimation result based on the sensor data. Accordingly, the state of the input device 16 at each time can be estimated with high accuracy.

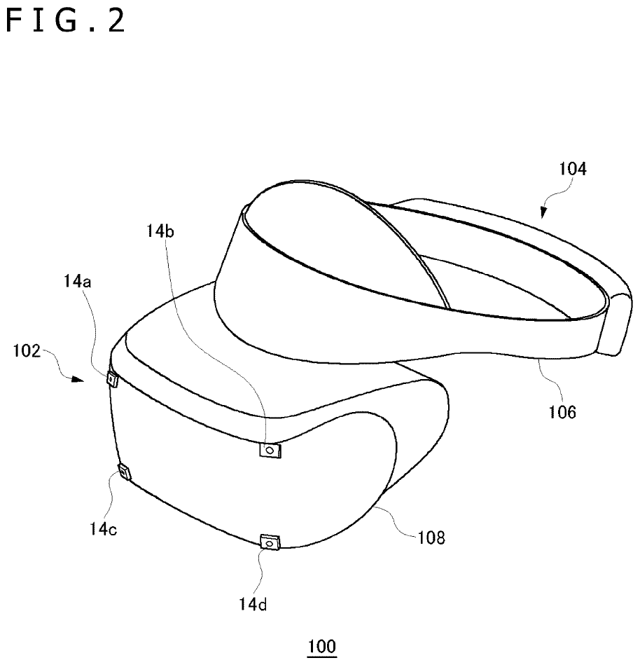

FIG. 2 depicts an example of the appearance shape of the head-mounted display 100. The head-mounted display 100 includes an output mechanism part 102 and a wearing mechanism part 104. The wearing mechanism part 104 includes a wearing band 106 that covers the circumference of the head of the user when being worn by the user and fixes the head-mounted display 100 to the head. The wearing band 106 has a material or a structure whose length can be adjusted according to the circumference of the head of the user.

The output mechanism part 102 includes a housing 108 having such a shape as to cover the left and right eyes of the user wearing the head-mounted display 100, and the housing 108 is provided therein with a display panel that faces the eyes of the user wearing the head-mounted display 100. The display panel may be a liquid crystal panel or an organic electroluminescent (EL) panel, for example. The housing 108 is further provided therein with a pair of left and right eyepiece lenses for enlarging the viewing angle of the user. The head-mounted display 100 may further be provided with speakers and earphones at positions corresponding to the ears of the user and may be configured such that external headphones are connected thereto.

The front outer surface of the housing 108 is provided with four imaging apparatuses 14a, 14b, 14c, and 14d. The plurality of imaging apparatuses 14 are mounted in this way with the directions of the optical axes made different from one another, so that the field of view of the user can be covered by the imaging range obtained by adding the respective imaging ranges of the imaging apparatuses 14. However, the number and arrangement of the imaging apparatuses 14 in the present embodiment are not limited to those illustrated in FIG. 2.

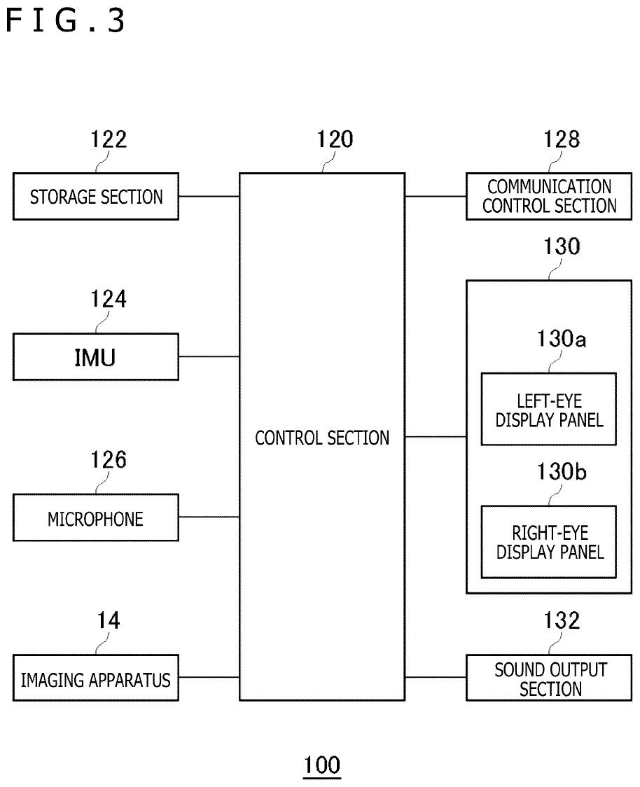

FIG. 3 depicts functional blocks of the head-mounted display 100. A control section 120 is a main processor that processes and outputs various types of data such as image data, sound data, and sensor data and commands. A storage section 122 temporarily stores the data and commands processed by the control section 120. An IMU 124 acquires sensor data related to the movement of the head-mounted display 100. The IMU 124 may include at least a three-axis acceleration sensor and a three-axis angular velocity sensor. The IMU 124 detects the value (sensor data) of each axis component at a predetermined cycle (e.g., 800 Hz).

A communication control section 128 transmits the data output from the control section 120 to the external information processing apparatus 10 by wired or wireless communication via a network adapter or an antenna. In addition, the communication control section 128 receives data from the information processing apparatus 10 and outputs it to the control section 120.

When receiving image data and sound data from the information processing apparatus 10, the control section 120 supplies the image data to a display panel 130 for display and also supplies the sound data to a sound output section 132 for sound output. The display panel 130 has a left-eye display panel 130a and a right-eye display panel 130b, and a pair of parallax images are displayed on the respective display panels. In addition, the control section 120 causes the communication control section 128 to transmit the sensor data from the IMU 124, sound data from a microphone 126, and data of captured images from the imaging apparatuses 14 to the information processing apparatus 10.

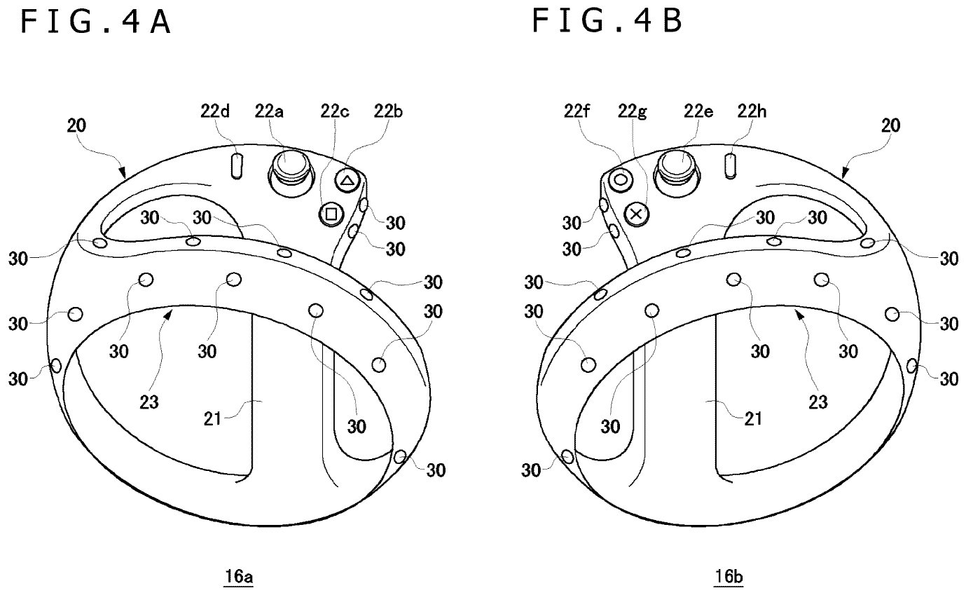

FIGS. 4A and 4B depict examples of the appearance shapes of the input devices 16. A left-hand input device 16a depicted in FIG. 4A is provided with a case body 20, a plurality of operating members 22a, 22b, 22c, and 22d to be operated by the user, and a plurality of markers 30 that emit light to the outside of the case body 20. The operating members 22 may include an analog stick for a tilting operation, push-down buttons, and the like. The case body 20 has a gripping part 21 and a curved part 23 connecting a top portion of the case body 20 and a bottom portion thereof to each other, and the user puts his or her left hand into the curved part 23 to grip the gripping part 21. While gripping the gripping part 21, the user operates the operating members 22a, 22b, 22c, and 22d by using the thumb of the left hand.

A right-hand input device 16b depicted in FIG. 4B is provided with the case body 20, a plurality of operating members 22e, 22f, 22g, and 22h to be operated by the user, and the plurality of markers 30 that emit light to the outside of the case body 20. The operating members 22 may include an analog stick for the tilting operation, push-down buttons, and the like. The case body 20 has the gripping part 21 and the curved part 23 connecting the top portion of the case body 20 and the bottom portion thereof to each other, and the user puts his or her right hand into the curved part 23 to grip the gripping part 21. While gripping the gripping part 21, the user operates the operating members 22e, 22f, 22g, and 22h by using the thumb of the right hand.

The markers 30 are light emitting parts that emit light to the outside of the case body 20, and include resin portions on the surface of the case body 20 that diffuse and emit light from light sources such as light emitting diode (LED) elements to the outside. The imaging apparatuses 14 capture images of the markers 30, and the captured images are used for tracking processing of the input devices 16.

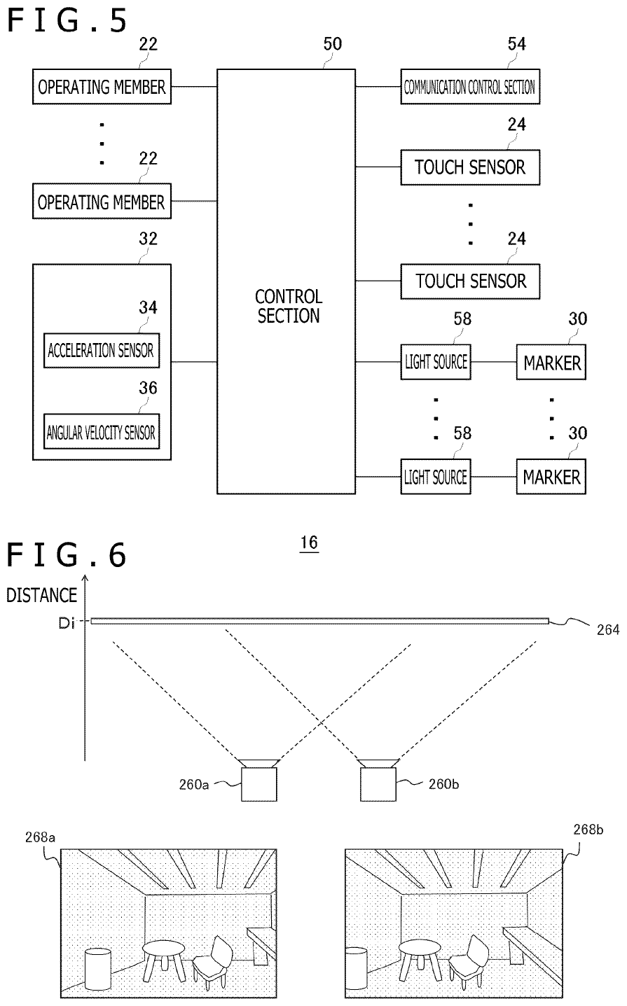

FIG. 5 depicts functional blocks of the input device 16. A control section 50 accepts operation information input to the operating members 22. In addition, the control section 50 accepts sensor data detected by an IMU 32 and sensor data detected by a touch sensor 24. The touch sensor 24 is attached to at least some of the plurality of operating members 22 to detect a state in which the fingers of the user are in contact with the operating members 22.

The IMU 32 includes an acceleration sensor 34 that acquires sensor data related to the movement of the input device 16 and detects at least three-axis acceleration data and an angular velocity sensor 36 that detects three-axis angular velocity data. The acceleration sensor 34 and the angular velocity sensor 36 detect the value (sensor data) of each axis component at a predetermined cycle (e.g., 800 Hz). The control section 50 supplies the accepted operation information and sensor data to a communication control section 54. The communication control section 54 transmits the operation information and the sensor data to the information processing apparatus 10 by wired or wireless communication via a network adapter or an antenna.

The input device 16 is provided with a plurality of light sources 58 for illuminating the plurality of markers 30. The light sources 58 may be LED elements that emit light of a predetermined color. When the communication control section 54 acquires a light emission instruction from the information processing apparatus 10, the control section 50 causes the light sources 58 to emit light on the basis of the light emission instruction, thereby illuminating the markers 30. It should be noted that, in the example depicted in FIG. 5, one light source 58 is provided for one marker 30, but one light source 58 may illuminate the plurality of markers 30.

The present embodiment provides a mode in which moving images being captured by the imaging apparatuses 14 of the head-mounted display 100 are displayed with a small delay, thereby allowing the user to see the state of the real space in the direction the user is facing, as it is. Hereinafter, such a mode is referred to as a “see-through mode.” For example, the head-mounted display 100 automatically operates in the see-through mode during a period when an image of content is not displayed.

Accordingly, the user can check his or her surroundings without removing the head-mounted display 100, for example, before the start of the content, after the end of the content, or at the time of the interruption of the content. In addition, the see-through mode may be started when the user explicitly performs an operation, or may be started or finished according to the situation such as when a play area is set or when the user deviates from the play area. Here, the play area is a range of the real world in which the user viewing a virtual world by the head-mounted display 100 can move around, and is, for example, a range in which safe movement is guaranteed without colliding with surrounding objects.

Images captured by the imaging apparatuses 14 can also be used as images of content. For example, AR and MR can be realized by synthesizing CG of a virtual object with the captured image such that the position, posture, and movement of the virtual object match those of a real object in the fields of view of the imaging apparatuses 14, and displaying the resultant image. In addition, regardless of whether or not the captured image is included in the display, the captured image is analyzed, and hence, the position, posture, and movement of the object to be drawn can be decided according to the analysis result.

For example, by performing stereo matching on the captured image, corresponding points of an image of a subject may be extracted, and the distance to the subject may be acquired by the principle of triangulation. Alternatively, the position and posture of the head-mounted display 100 and hence the position and posture of the head of the user in the surrounding space may be acquired by a well-known technique such as visual simultaneous localization and mapping (SLAM). Visual SLAM is a technique for acquiring the positions and postures of the imaging apparatuses 14 and an environment map in parallel by acquiring the three-dimensional position coordinates of feature points on an object surface on the basis of corresponding points extracted from a stereo image and tracking the feature points in frames in time-series order.

FIG. 6 is a diagram for explaining the relation between a three-dimensional space forming the display world of the head-mounted display 100 and a display image generated from the captured image. It should be noted that, in the following explanation, the captured image converted into a display image is referred to as a see-through image regardless of whether or not the mode is the see-through mode. An upper portion of FIG. 6 depicts a state in which a virtual three-dimensional space (hereafter, referred to as a display world) configured at the time of generating display images is seen from a bird's-eye view. Virtual cameras 260a and 260b are virtual rendering cameras for generating display images, and correspond to the left viewpoint and the right viewpoint of the user, respectively. The upward direction in FIG. 6 represents the depth direction (distance from the virtual cameras 260a and 260b).

See-through images 268a and 268b correspond to images obtained by capturing an interior space in front of the head-mounted display 100 by the imaging apparatuses 14, and correspond to one frame of display images for the left eye and the right eye. Needless to say, when the user changes the direction of the face, the fields of view of the see-through images 268a and 268b are also changed. In order to generate the see-through images 268a and 268b, the head-mounted display 100 or the information processing apparatus 10 arrange, for example, a captured image 264 at a predetermined distance Di in the display world.

More specifically, the head-mounted display 100 represents a left-viewpoint captured image 264 and a right-viewpoint captured image 264 which are obtained by the imaging apparatuses 14, on the respective inner surfaces of spheres having a radius Di with the virtual cameras 260a and 260b as centers, for example. Then, the head-mounted display 100 generates the see-through image 268a for the left eye and the see-through image 268b for the right eye by drawing images obtained by viewing the captured images 264 from the virtual cameras 260a and 264b.

Accordingly, the captured images 264 obtained by the imaging apparatuses 14 are converted into images from the viewpoint of the user viewing the display world. Here, an image of the same subject appears to the right in the see-through image 268a for the left eye and to the left in the see-through image 268b for the right eye. Since a left-viewpoint captured image and a right-viewpoint captured image are originally obtained with parallax, an image of a subject appears with various amounts of deviation in the see-through images 268a and 268b according to the actual position (distance) of the subject. Accordingly, the user perceives a sense of distance in the image of the subject.

As described above, the captured image 264 is represented on a uniform virtual surface, and an image obtained by viewing the captured image 264 from a viewpoint corresponding to the user's viewpoint is used as the display image, so that the captured image with a sense of depth can be displayed without constructing a three-dimensional virtual world in which the arrangement and structure of a subject are accurately traced. In addition, when the surface (hereafter, referred to as a projection surface) on which the captured image 264 is represented is a spherical surface that keeps a predetermined distance from the virtual cameras 260, an image of an object present in an assumed range regardless of the direction can be represented with uniform quality. As a result, it is possible to both achieve a low delay and give a sense of presence with a small processing load.

On the other hand, an image of a real object displayed by the illustrated display method can be slightly different from the real object in the real world when the real world is directly viewed. The difference is hardly noticed when only the see-through image is displayed, but it is likely to become apparent as a positional deviation from CG in the case where the CG is synthesized. While CG generally represents a state in which a three-dimensional model of a virtual object is viewed from the viewpoint of the user, a see-through image is originally data separately obtained as a two-dimensional captured image, which causes the positional deviation. Therefore, in the present embodiment, CG is drawn assuming the position of an image of a real object in a see-through image, so that a synthesis image with a small positional deviation can be displayed.

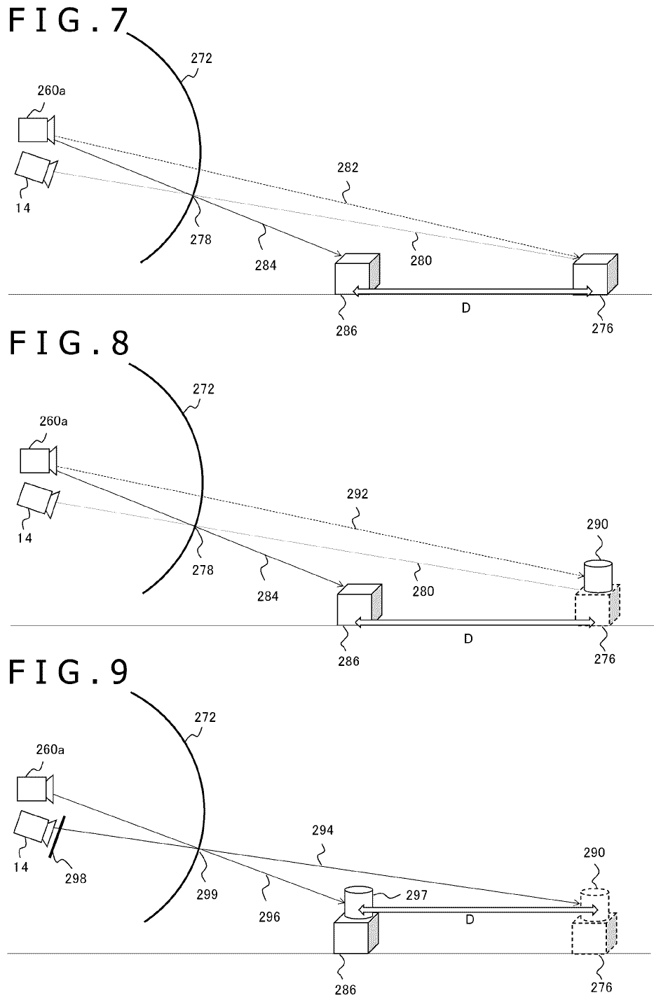

FIG. 7 is a diagram for explaining the difference from the real world that can occur in a see-through image in the present embodiment. FIG. 7 depicts a state in which the three-dimensional space of the display world depicted in the upper portion of FIG. 6 is viewed from the side, and illustrates one of the left and right virtual cameras, i.e., the virtual camera 260a, and a corresponding camera among the imaging apparatuses 14. As described above, the see-through image represents a state in which an image captured by the imaging apparatus 14 is projected onto a projection surface 272 and viewed from the virtual camera 260a. The projection surface 272 is, for example, an inner surface of a sphere having a radius of 2 m with the virtual camera 260a as a center. However, the shape and size of the projection surface are not limited thereto.

The virtual camera 260a and the imaging apparatus 14 are interlocked with the movement of the head-mounted display 100 and hence the head of the user. For example, when a rectangular parallelepiped real object 276 enters the field of view of the imaging apparatus 14, an image of the real object 276 is projected onto the projection surface 272 near a position 278 where a line of sight 280 from the imaging apparatus 14 to the real object 276 crosses the projection surface 272. In a see-through image obtained by viewing this image from the virtual camera 260a, the real object 276, which should originally be in the direction of a line of sight 282, is represented in the direction of a line of sight 284. As a result, the user sees the real object 276 as if it is present in front by a distance D (on-display real object 286).

FIG. 8 is a diagram for explaining the principle of occurrence of a positional deviation when CG is synthesized with the see-through image. FIG. 8 assumes that a virtual object 290 is represented by CG so as to be on the real object 276 in the environment depicted in FIG. 7. In this case, in general, the three-dimensional position coordinates of the real object 276 are obtained first, and the position of the virtual object 290 in the display world is decided so as to correspond to the position of the real object 276.

Then, a state in which the virtual object 290 is viewed from the virtual camera 260a is drawn as a CG image, and the CG image is synthesized with the see-through image. Needless to say, according to this procedure, the virtual object 290 on display is expressed so as to be in the direction of a line of sight 292 from the virtual camera 260a to the virtual object 290. On the other hand, as described with reference to FIG. 7, since the real object 276 is expressed as the on-display real object 286 that is in front by the distance D, the user sees both objects as if they deviate from each other.

This phenomenon is caused by the difference in the optical center and the optical axis direction between the imaging apparatus 14 and the virtual camera 260a. In other words, the real object 276 is projected onto a screen coordinate system of the virtual camera 260a via a screen coordinate system corresponding to an imaging surface of the imaging apparatus 14 and the projection surface 272, while the virtual object 290 is directly projected onto the screen coordinate system of the virtual camera 260a, which causes the positional deviation between them. Therefore, the present embodiment includes processing in which the virtual object 290 is projected onto the screen coordinate system of the imaging apparatus 14 or the projection surface 272, so that the image (CG) is aligned with the image of the real object 276.

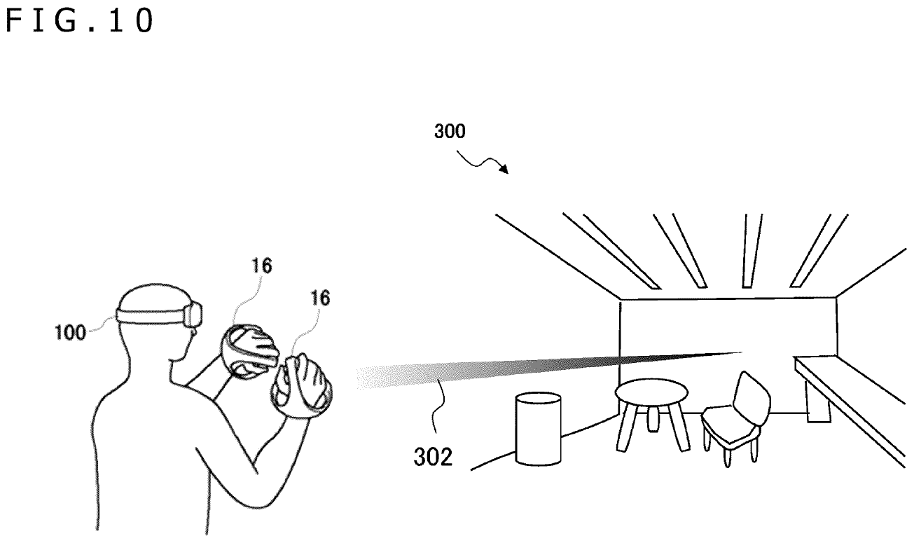

FIG. 9 is a diagram for explaining a method of aligning CG with the image of the real object. Also in this case, similarly to the case of FIG. 8, the three-dimensional position coordinates of the real object 276 are obtained, and the position of the virtual object 290 is decided so as to correspond to the position of the real object 276. Further, according to the present embodiment, an intermediate image of the virtual object 290 is generated so as to follow the projection through which the real object 276 is represented as the see-through image.

Specifically, the state of the virtual object 290 viewed from the imaging apparatus 14 is represented as an intermediate image by projecting the virtual object 290 onto a screen coordinate system 298 of the imaging apparatus 14. Alternatively, a state in which an image obtained by viewing the virtual object 290 from the imaging apparatus 14 is projected onto the projection surface 272 may directly be represented in the vicinity of a position 299 as an intermediate image. In any case, with these intermediate images, the virtual object 290 is represented in the direction of a line of sight 294 viewed from the imaging apparatus 14.

That is, the viewpoint of the virtual object 290 is unified with the viewpoint of the captured image. Thus, the remaining processing is thereafter performed similarly to the generation of the see-through image, and the CG and the see-through image are synthesized at some stage, so that an image with no positional deviation between the CG and the image of the real object can be displayed. It should be noted that, in this case, the virtual object 290 is represented in the direction of the line of sight 296 from the virtual camera 260a. That is, as in the case of FIG. 7, the user sees the virtual object 290 as if it is present in front by the distance D (on-display virtual object 297), but it is hard to be noticed by the user since the positional deviation from the on-display real object 286 is eliminated. This allows the user to feel as if the user is seeing a synthesis image with high accuracy as a whole.

FIG. 10 exemplifies a mode in which the user interacts with the display world via a virtual object in the present embodiment. FIG. 10 depicts a virtual situation in which a user wearing the head-mounted display 100 is in a three-dimensional space 300. The three-dimensional space 300 is, for example, a living room of the user, and by displaying a see-through image, the user can look around the living room with a feeling as if the user is not wearing the head-mounted display 100. In a situation in which the user makes some kind of designation and selection to the three-dimensional space 300, such as setting a play area, the information processing apparatus 10 causes a user-operable designation object 302 to appear.

In FIG. 10, the designation object 302 is represented in a form of a ray of light, but the form is not particularly limited. The information processing apparatus 10 represents the designation object 302 in the three-dimensional space 300 such that the designation object 302 extends in a predetermined direction from a predetermined position of one input device 16. Accordingly, the user can easily designate a desired position in the three-dimensional space 300 by changing the position and posture of the input device 16.

For example, when the user designates a certain position by the designation object 302 and presses the operating member of the input device 16, the information processing apparatus 10 accepts the designated position or object as a selection target. Alternatively, when the user draws a closed curve by using the designation object 302 while pressing the operating member of the input device 16, the information processing apparatus 10 accepts an inner area surrounded by the closed curve as a selection area. It will be understood by those skilled in the art that various other input operations can be performed by the designation object 302.

FIG. 11 schematically depicts an example of an image to be displayed on the head-mounted display 100 when the user sets a play area by the designation object. It should be noted that, although one display image is depicted in FIG. 11, images having parallax for the left and right eyes are actually displayed as described above. The illustrated display image is based on a see-through image 304 obtained by capturing an image of the living room of the user on a real time basis. The see-through image 304 includes an image 306 of a hand of the user and an image 308 of the input device being gripped.

When setting a play area, the information processing apparatus 10 additionally represents a designation object 310 in the see-through image 304. More specifically, the information processing apparatus 10 arranges a three-dimensional model of the designation object 310 in a three-dimensional space on the basis of the position and posture of the input device 16 and then draws a state in which the designation object 310 is viewed from a virtual camera for display. The user draws a boundary line of the play area on a floor surface of the living room by moving the destination of the designation object 310 using the input device 16. The information processing apparatus 10 further draws a line 312 representing a path of the designation object 310 and a pattern (e.g., a pattern 314) representing the inside of the play area.

When a setting completion operation is performed by the user, the information processing apparatus 10 stores, as a play area, an area on the floor corresponding to an inner area surrounded by the drawn boundary line. Information regarding the stored play area is used, for example, to give a warning when the user is about to deviate from the play area in a period when the VR game is executed. Accordingly, it is possible to prevent the user who hardly see the surrounding real space from colliding with furniture or the like.

In such a mode, as depicted in FIG. 9, the information processing apparatus 10 first generates an intermediate image by representing the designation object 310 and the line 312 of the path on the screen coordinate system of the imaging apparatus 14 or the projection surface for the see-through image, and then represents the intermediate image on the screen coordinate system of the virtual camera. Accordingly, the designation object 310 and the line 312 of the path are apparently not deviated from the image 308 of the input device and the image on the floor. However, it should be noted that this processing is for aligning objects on the display, and the arrangement of the designation object 310 itself and the destination thereof are calculated in the three-dimensional space.

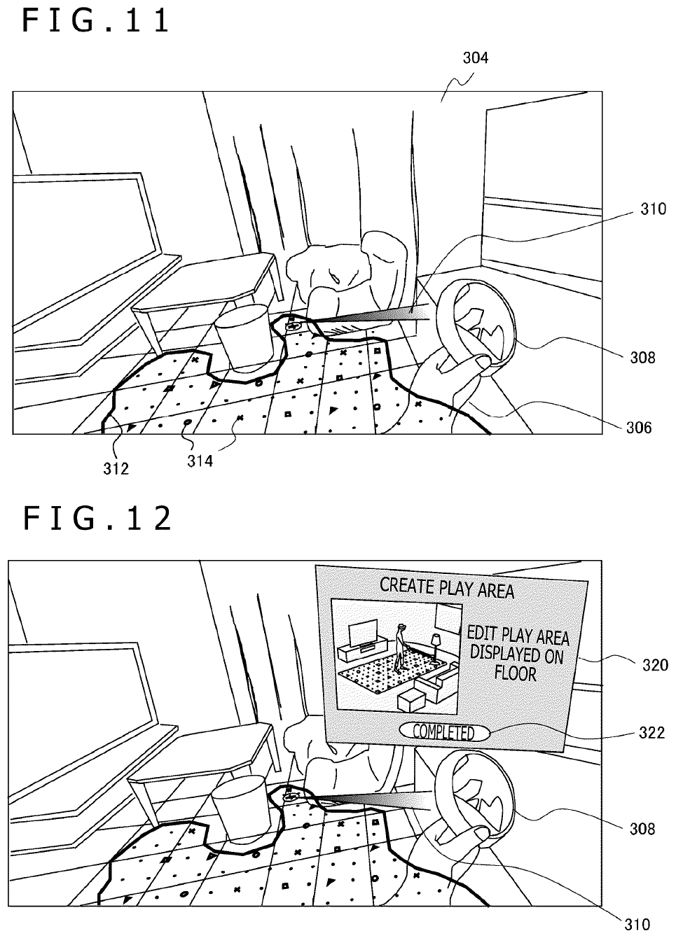

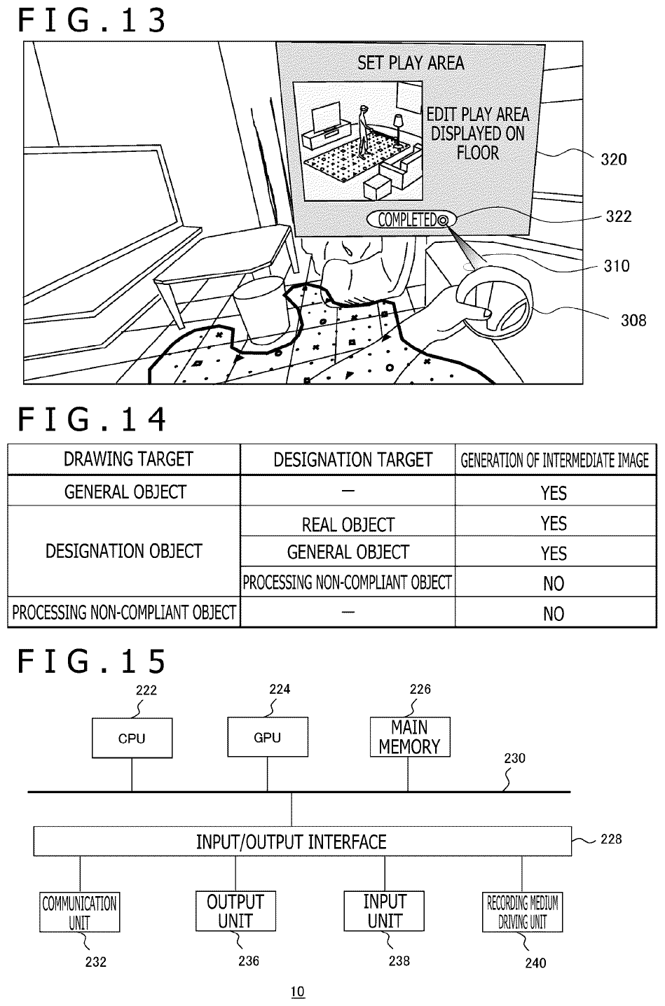

On the other hand, in the case of an object specified to be directly drawn on the screen coordinate system of a virtual camera, such as an object of a template provided by middleware, it becomes difficult to generate an intermediate image. FIGS. 12 and 13 schematically depict examples of display images including an object for which the intermediate image is not allowed to be generated. In these examples, dialogs 320 for giving an instruction for setting of a play area are added to the display image depicted in FIG. 11.

For example, as depicted in FIG. 12, the user checks a method of setting a play area by seeing text and an image in the dialog 320, and draws the boundary of the play area on the floor surface by using the designation object 310. Subsequently, as depicted in FIG. 13, the user designates a graphical user interface (GUI) 322 representing “completed” in the dialog 320 by using the designation object 310 to input the completion of the setting of the play area.

Similarly to other virtual objects, the dialog 320 is basically drawn as a state in which an object arranged at a predetermined position in the three-dimensional space is viewed from the virtual camera for display. On the other hand, in the case where a template for which it is difficult to generate an intermediate image is used as the dialog 320, an image of the dialog 320 is directly drawn on the screen coordinate system of the virtual camera by a general method. Hence, the positional relation between a real object or other objects and the dialog 320 appears to be different from the positional relation set in the three-dimensional space by the principle similar to that depicted in FIG. 8.

As a result, it becomes difficult to operate the GUI 322. For example, even when the user designates the GUI 322 by the designation object 310, collision detection is not made on the calculation, so that the user fails to complete the setting operation of the play area. Such a problem may occur not only in the operation of the GUI 322 but also in any interaction between the designation object 310 and the dialog 320.

Therefore, the information processing apparatus 10 switches whether or not to use an intermediate image when drawing the designation object 310, according to predetermined conditions. Here, examples of the switching condition include an attribute of a designation target. For example, as depicted in FIG. 12, in the case where the see-through image is the designation target, the information processing apparatus 10 uses an intermediate image in the drawing of the designation object 310. On the other hand, as depicted in FIG. 13, in the case where the dialog 320 is the designation target, the information processing apparatus 10 directly draws the designation object 310 on the screen coordinate system of the virtual camera.

This ensures that the positional relation between the designation object 310 and the designation target is represented in a similar manner to the positional relation in the three-dimensional space, and thus, a stable designation operation can be performed regardless of the designation target. It should be noted that, in a period in which an intermediate image is not used in the drawing of the designation object 310, a positional deviation may occur between the designation object 310 and an image of a real object in the see-through image by the principle depicted in FIG. 8. For example, it is conceivable that a proximal end of the designation object 310 and the image 308 of the input device may be deviated from each other, but such a deviation is hardly noticeable since the user is likely to pay attention to the designation target due to the characteristics of the designation operation, and thus, the deviation hardly interferes with the operation.

An object such as the dialog 320 which is difficult to be drawn using an intermediate image is hereinafter referred to as a “processing non-compliant object”. The type of processing non-compliant object is not limited to the dialog as illustrated in FIG. 12 or the like, and the reason why an intermediate image is not allowed to be used is also not particularly limited. For example, the processing non-compliant object may be an object such as an avatar of a communication partner in a mode where a three-dimensional model transmitted from the outside is immediately displayed by an existing program.

In addition, the target for which whether or not to generate an intermediate image is switched is not limited to the designation object. For example, in the case where interaction between an object reflecting the movement of a body part of the user such as a hand and another object is expressed according to collision detection therebetween, the information processing apparatus 10 may switch whether or not to use an intermediate image in the drawing of the object reflecting the movement of the body part, according to whether or not the other object is the processing non-compliant object. In the present embodiment, a medium that is operated by the user to achieve interaction with the display world even with no strict designation is referred to as the “designation object,” and a target that comes into contact with the designation object is referred to as the “designation target.”

The condition for switching whether or not to use an intermediate image in the drawing of the designation object is not limited to the attribute of the designation target. For example, the information processing apparatus 10 may stop using the intermediate image when any of conditions such as predetermined content, a predetermined scene in content, a period during which the processing non-compliant object is displayed, and a mode selection by the user is satisfied. In addition, in the case where the intermediate image is stopped to be used on the condition that the designation target becomes the processing non-compliant object, the timing of the stopping is not limited to a timing when the designation object comes into contact with the processing non-compliant object, and may be a timing when the designation object enters a predetermined range with a predetermined margin from the processing non-compliant object. In summary, the information processing apparatus 10 switches whether or not to use an intermediate image in the drawing of the designation object, according to the state of the display world including the designation object.

FIG. 14 depicts an example of setting whether or not to use an intermediate image when the information processing apparatus 10 draws a virtual object. First, in the case where a drawing target is a “general object” that is not the designation object or the processing non-compliant object, the information processing apparatus 10 draws an image of the general object by using an intermediate image. That is, the information processing apparatus 10 first generates an intermediate image representing the general object and then represents the image on the screen coordinate system of the virtual camera. Accordingly, the image of the general object is steadily fitted to the real object in the see-through image.

In the case where the drawing target is the “designation object,” the information processing apparatus 10 switches whether or not to use an intermediate image, according to the attribute of the designation target. Specifically, when the designation target is a “real object” in the see-through image or a “general object,” the information processing apparatus 10 draws an image of the designation object by using an intermediate image. When the designation target is the “processing non-compliant object,” the information processing apparatus 10 directly draws an image of the designation object on the screen coordinate system of the virtual camera without using an intermediate image. In the case where the drawing target is the “processing non-compliant object,” since an intermediate image is not allowed to be generated, the information processing apparatus 10 directly draws an image of the object on the screen coordinate system of the virtual camera.

FIG. 15 depicts an internal circuit configuration of the information processing apparatus 10. The information processing apparatus 10 includes a central processing unit (CPU) 222, a graphics processing unit (GPU) 224, and a main memory 226. These units are connected to on another via a bus 230. An input/output interface 228 is further connected to the bus 230. A communication unit 232, an output unit 236, an input unit 238, and a recording medium driving unit 240 are connected to the input/output interface 228.

The communication unit 232 includes a peripheral equipment interface such as an universal serial bus (USB) or Institute of Electrical and Electronics Engineers (IEEE) 1394 and a network interface such as a wired local area network (LAN) or a wireless LAN. The output unit 236 outputs data to the head-mounted display 100 or the recording apparatus 11. The input unit 238 acquires data from the head-mounted display 100, the input devices 16 and the recording apparatus 11. The recording medium driving unit 240 drives a removable recording medium such as a magnetic disk, an optical disk, or a semiconductor memory.

The CPU 222 controls the entire information processing apparatus 10 by executing an operating system loaded from the recording apparatus 11 into the main memory 226. In addition, the CPU 222 executes various programs (e.g., VR game applications and the like) that are read from the recording apparatus 11 or the removable recording medium and loaded into the main memory 226 or that are downloaded via the communication unit 232. The GPU 224 has the function of a geometry engine and the function of a rendering processor, performs drawing processing according to a drawing command from the CPU 222, and outputs a drawing result to the output unit 236. The main memory 226 includes a random access memory (RAM) and stores programs and data necessary for processing.

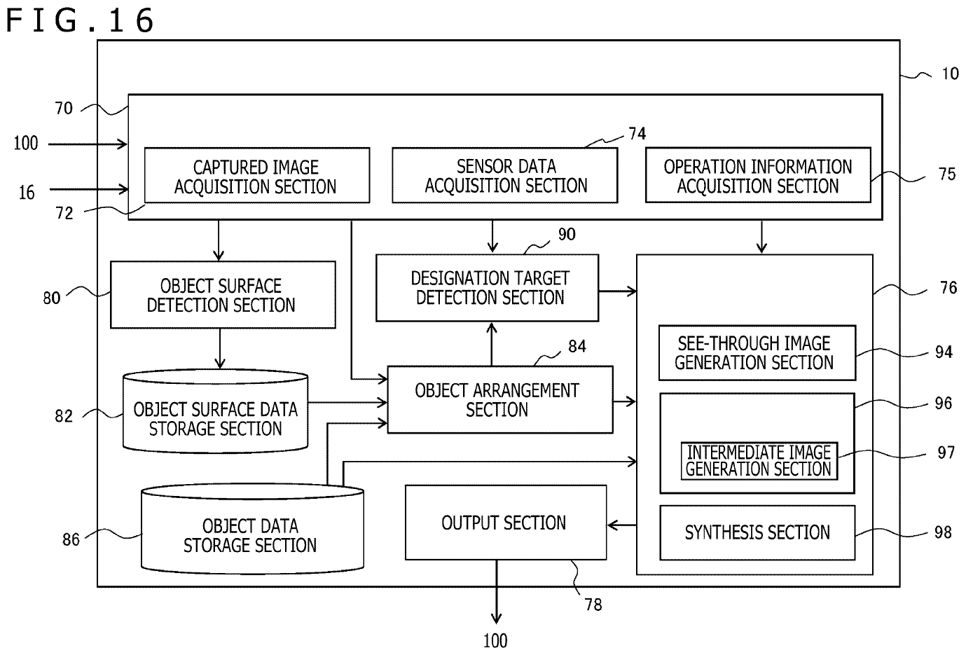

FIG. 16 depicts a configuration of functional blocks of the information processing apparatus 10 according to the present embodiment. In terms of hardware, the illustrated functional blocks can be implemented by the circuit configuration depicted in FIG. 15, and in terms of software, they are implemented by programs that are loaded from the recording apparatus 11 into the main memory 226 and that exhibit various functions such as a data input function, a data holding function, an image processing function, and a communication function. Therefore, it will be understood by those skilled in the art that these functional blocks can be implemented in various forms by hardware alone, software alone, or a combination thereof, and are not limited to any of them.

In addition, while the information processing apparatus 10 may have a function of processing various types of electronic content and communicating with the server as described above, FIG. 16 depicts a configuration of a function of synthesizing CG with a see-through image and displaying the resultant image on the head-mounted display 100. In this regard, the information processing apparatus 10 may be a display image generation apparatus. It should be noted that the head-mounted display 100 may include some of the illustrated functional blocks.

The information processing apparatus 10 includes a data acquisition section 70 that acquires various types of data from the head-mounted display 100 and the input devices 16, a display image generation section 76 that generates data of a display image, and an output section 78 that outputs the data of the display image. The information processing apparatus 10 further includes an object surface detection section 80 that detects the surface of a real object, an object surface data storage section 82 that stores data of the object surface, an object arrangement section 84 that arranges a virtual object in the display world, an object data storage section 86 that stores data of the virtual object, and a designation target detection section 90 that detects a target designated by the designation object.

The data acquisition section 70 continuously acquires various types of data necessary for generating a display image from the head-mounted display 100 and the input devices 16. Specifically, the data acquisition section 70 includes a captured image acquisition section 72, a sensor data acquisition section 74, and an operation information acquisition section 75. The captured image acquisition section 72 acquires data of a captured image obtained by the imaging apparatus 14 from the head-mounted display 100 at a predetermined frame rate.

The sensor data acquisition section 74 acquires sensor data detected by the IMU 124 of the head-mounted display 100 and the touch sensors 24 and the IMUs 32 of the input devices 16 at a predetermined rate. The sensor data detected by the IMUs may be measured values such as acceleration or angular acceleration or may be data derived from the measured values, such as translational motion or rotational motion and hence the position and posture at each time. In the former case, the sensor data acquisition section 74 derives the positions and postures of the head-mounted display 100 and the input devices 16 at a predetermined rate by using the acquired measured values. When the user operates the operating members 22 of the input devices 16, the operation information acquisition section 75 acquires operation information indicating the details of the operation.

The object surface detection section 80 detects the surface of a real object around the user in the real world. For example, the object surface detection section 80 generates data of an environmental map that represents the distribution of feature points on the object surface in a three-dimensional space. In this case, the object surface detection section 80 sequentially acquires data of captured images from the captured image acquisition section 72, and executes the above-described Visual SLAM to generate the data of the environmental map. However, the detection method performed by the object surface detection section 80 and the expression form of the detection result are not particularly limited. The object surface data storage section 82 stores data indicating the result of the detection by the object surface detection section 80, for example, the data of the environmental map.

The object data storage section 86 stores arrangement rules of virtual objects to be displayed and data of three-dimensional models to be represented by CG. Examples of the attributes of the virtual objects to be displayed include the general object, the designation object, and the processing non-compliant object as depicted in FIG. 14.

The line 312 and the pattern 314 in FIG. 11 belong to the general objects. The designation object 310 in FIG. 11 and the dialog 320 in FIG. 12 belong to the designation object and the processing non-compliant object, respectively. The object data storage section 86 also stores information for distinguishing the attributes of objects from each other in association with a model of each object.

The object arrangement section 84 specifies a virtual object to be displayed, on the basis of the operation information acquired by the data acquisition section 70, and then arranges the specified virtual object in the three-dimensional space of the display world on the basis of the information stored in the object data storage section 86. In the case where the virtual object is represented according to the position and movement of a real object as depicted in FIG. 8, the object arrangement section 84 acquires three-dimensional position information of the object surface such as an environment map from the object surface data storage section 82, and decides the three-dimensional position and posture of the virtual object so as to correspond thereto.

The designation target detection section 90 detects a target designated by the user using the designation object. Specifically, the designation target detection section 90 acquires the position and posture of the designation object in the three-dimensional space from the object arrangement section 84, and specifies the position coordinates of the designation destination. It should be noted that the unit of the designation target to be detected by the designation target detection section 90 is not limited to the position coordinates, and may be a unit having an area such as an object unit or a GUI unit. Alternatively, the unit may be an image type such as a see-through image or CG.

In addition, as described above, the designation target detection section 90 may determine a detection unit as the designation target when the destination designated by the designation object reaches a region in a predetermined range including an image of the detection unit. Alternatively, the designation target detection section 90 may predict the arrival of the designation destination on the basis of the movement of the designation object and decide the designation target.

The display image generation section 76 generates a see-through image by using captured images sequentially acquired by the captured image acquisition section 72 of the data acquisition section 70, and generates a display image by synthesizing CG with the see-through image. Specifically, the display image generation section 76 includes a see-through image generation section 94, an object drawing section 96, and a synthesis section 98. The see-through image generation section 94 projects the captured image onto a projection surface of a predetermined shape, and then represents a state in which the projected image is viewed from the virtual camera for display, as the see-through image.

The object drawing section 96 draws an image of the virtual object in the three-dimensional space arranged by the object arrangement section 84, as an image viewed from the virtual camera for display. The object drawing section 96 includes an intermediate image generation section 97. As depicted in FIG. 14, the object drawing section 96 operates the intermediate image generation section 97 when drawing the general object and when drawing the designation object that is used to designate an object other than the processing non-compliant object. In the case where the intermediate image generation section 97 is not operated, the object drawing section 96 directly draws an object to be drawn on the screen coordinate system of the virtual camera.

The intermediate image generation section 97 generates an intermediate image such that a viewpoint to a virtual object arranged in the three-dimensional space by the object arrangement section 84 is aligned with a viewpoint to a real object represented in the captured image. As a procedure for drawing a virtual object by the object drawing section 96 in the case where the intermediate image generation section 97 functions, the following two types of procedures are available, for example.

### Procedure a

The intermediate image generation section 97 generates an intermediate image by drawing a virtual object on the screen coordinate system of the imaging apparatus 14. Accordingly, a viewpoint to a captured image and a viewpoint to the virtual object to be drawn are already aligned. In this case, the object drawing section 96 projects the intermediate image onto the projection surface (e.g., the projection surface 272 in FIG. 9) similarly to the case of generating a see-through image, and represents a state in which the intermediate image is viewed from the virtual camera 260, thereby obtaining the final image of the virtual object.

### Procedure b

The intermediate image generation section 97 draws (projects) an image of a virtual object viewed from the imaging apparatus 14, onto the projection surface (e.g., the projection surface 272 in FIG. 9) onto which a captured image is projected upon generation of a see-through image, and uses the resultant image as an intermediate image. That is, the intermediate image generation section 97 draws the virtual object in the same state as the captured image projected onto the projection surface 272. In this case, the object drawing section 96 obtains the final image of the virtual object by representing a state in which the intermediate image is viewed from the virtual camera 260.

The synthesis section 98 synthesizes the see-through image generated by the see-through image generation section 94 and the image of the virtual object drawn by the object drawing section 96, to obtain a display image. It should be noted that, in the case where the intermediate image generation section 97 is operated according to the procedure a, the synthesis section 98 may synthesize the image of the virtual object with the captured image at the stage when the intermediate image is generated on the screen coordinate system of the imaging apparatus 14. In this case, instead of the object drawing section 96, the synthesis section 98 projects the synthesized image onto the projection surface and then represents a state in which the synthesized image is viewed from the virtual camera 260, thereby generating the final display image. Thus, by drawing and synthesizing the virtual object according to the viewpoint of the imaging apparatus 14 first, a natural display image can be generated regardless of the density of polygons.

In addition, since the drawing of the virtual object on the projection surface in the procedure b can be performed by well-known projection transformation without drawing the virtual object on the screen coordinate system of the imaging apparatus 14, the processing can be performed faster. Even in either of the procedures, by operating the intermediate image generation section 97, it is possible to finally generate a display image in which there is no positional deviation between the captured image of the real object and the image of the virtual object.

The position of a viewpoint and the direction of a line of sight of the imaging apparatus 14, the position and posture of a projection surface, and the position and posture of the virtual camera 260, which are used when the display image generation section 76 generates an intermediate image or a display image, depend on the movement of the head-mounted display 100 and hence the head of the user. Therefore, the display image generation section 76 decides these parameters at a predetermined rate on the basis of the data acquired by the data acquisition section 70.

It should be noted that the operation of the intermediate image generation section 97 is not limited to the actual drawing of CG as an intermediate image, and the intermediate image generation section 97 may only generate information that decides the position and posture of the image. For example, the intermediate image generation section 97 may represent only vertex information of a virtual object on the image plane as an intermediate image. Here, the vertex information may be data used for general CG drawing, such as position coordinates, normal vectors, colors, and texture coordinates. In this case, it is sufficient if the display image generation section 76 draws an actual image while appropriately converting the viewpoint on the basis of the intermediate image at, for example, the stage of synthesizing with a see-through image. Accordingly, the load required for generating an intermediate image is reduced, and the synthesis image can be generated at a faster speed.

The output section 78 acquires data of a display image from the display image generation section 76, performs processing necessary for display, and sequentially outputs it to the head-mounted display 100. The display image has a pair of images for the left eye and the right eye. The output section 78 may correct the display image in the direction of canceling distortion aberration and chromatic aberration such that an image without distortion can be visually recognized when viewed through the eyepiece lens. The output section 78 may also perform various types of data conversions compliant with the display panel of the head-mounted display 100.

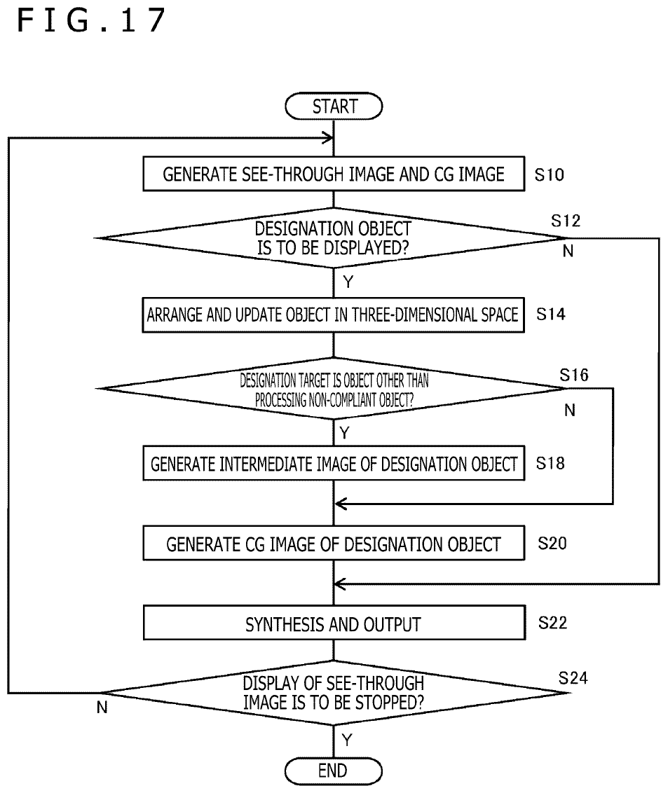

Next, an operation of the information processing apparatus 10 that can be implemented by the above configuration will be described. FIG. 17 is a flowchart for depicting a processing procedure for generating a see-through image with which CG of a virtual object can be synthesized, by the information processing apparatus 10. This flowchart is performed, for example, during a period in which a play area is set, but the details and purpose of the display are not intended to be limited thereto. In addition, although only the procedure directly related to the generation of a display image is depicted in FIG. 17, the data acquisition section 70 of the information processing apparatus 10 appropriately acquires necessary data from the head-mounted display 100 and the input devices 16 in parallel with the depicted procedure. In addition, the object surface detection section 80 appropriately acquires the position and posture of an object surface and stores them in the object surface data storage section 82.

First, the display image generation section 76 generates a see-through image on the basis of the latest captured image at that time (S10). That is, the display image generation section 76 projects the captured image onto a predetermined projection surface in the three-dimensional space, and then generates a see-through image representing a state in which the captured image is viewed from the virtual camera for display. It should be noted that the time and place in which the image represented as the see-through image is captured are not limited by the purpose of display, and an image captured in advance may be used as a display target. In addition, the display target is not limited to a captured image, and may be a separately generated CG image or an image obtained by synthesizing the captured image and CG.

In the processing of S10, the display image generation section 76 also generates CG images of the general object and the processing non-compliant object as necessary. In this case, the display image generation section 76 represents each object arranged in the three-dimensional space by the object arrangement section 84, on the screen coordinate system of the virtual camera. Here, the display image generation section 76 first generates an intermediate image of the general object, and then represents it on the screen coordinate system of the virtual camera. As for the processing non-compliant object, it is directly drawn on the screen coordinate system of the virtual camera.

If it is not necessary to display the designation object (N in S12), the see-through image and CG image generated in S10 are appropriately synthesized by the collaboration of the display image generation section 76 and the output section 78, and the resultant image is output to the head-mounted display (S22). If it is necessary to display the designation object (Y in S12), the object arrangement section 84 arranges the designation object in the three-dimensional space (S14). For example, the position and posture of the designation object are decided according to the position and posture of the input device 16 held by the user.

Next, the designation target detection section 90 checks whether or not a target designated by the designation object is an object other than the processing non-compliant object (S16). In the case where the designation target is not the processing non-compliant object (Y in S16), the display image generation section 76 first generates an intermediate image (S18) similarly to the case of the general object, and then generates a CG image by representing the intermediate image on the screen coordinate system of the virtual camera (S20). In the case where the designation target is the processing non-compliant object (N in S16), the display image generation section 76 directly draws the designation object on the screen coordinate system of the virtual camera similarly to the case of the processing non-compliant object (S20).

Then, an image of the designation object is synthesized with the see-through image by the collaboration of the display image generation section 76 and the output section 78, and the resultant image is output to the head-mounted display 100 (S22). It should be noted that the processing of synthesizing the CG image with the see-through image by the display image generation section 76 may be performed at the stage when the intermediate image is generated, as described above. In addition, the display image generation section 76 may determine in S16 whether or not to use an intermediate image, by using a criterion other than whether or not a target designated by the designation object is an object other than the processing non-compliant object.

During a period when it is not necessary to stop the display of the see-through image (N in S24), the information processing apparatus 10 repeats the processing of S10 to S22 at, for example, a predetermined rate. When it is necessary to stop the display of the see-through image, the information processing apparatus 10 terminates all the processing (Y in S24).

According to the present embodiment described above, when a captured image and an image of a three-dimensional virtual object are synthesized and displayed, an intermediate image representing the image of the virtual object from the viewpoint of the camera is first generated, and the intermediate image is then used as an image from the viewpoint for display. Accordingly, it is possible to generate a synthesis image in which there is no positional deviation between the virtual object and the image of the real object, without performing high-load processing such as processing of strictly associating the captured image with the three-dimensional real space structure.

In addition, for a specific object such as the designation object serving as a medium for allowing the user to interact with the display world, whether or not to use an intermediate image can be switched. Accordingly, even if an object having specifications that do not allow the generation of an intermediate image is included in the display, the intended designation and interaction can be realized similarly to other objects. As a result, even with a small processing load, it is possible to continuously display the captured image and the three-dimensional object steadily in an appropriate positional relation. In addition, the user can appropriately perform an operation by using the virtual object regardless of the situation.

The present disclosure has been described above on the basis of the embodiment. It will be understood by those skilled in the art that the embodiment is an example, various modifications can be made to the combinations of the respective constituent elements and the respective processing processes, and such modifications are also within the scope of the present disclosure.

For example, in the case of a display system in which the viewpoints of a captured image and a display image are different from each other, the display apparatus can be applied without being limited to the head-mounted display.

The present disclosure may include the following aspects.

### Item 1

A display image generation apparatus that is a content server including circuitry configured as follows. The circuitry acquires data of an image captured by a camera, arranges a virtual object to be operated by a user in a virtual three-dimensional space, generates a display image by drawing an image of the virtual object and synthesizing the image of the virtual object with the captured image, and outputs data of the display image. In generating the display image, the circuitry switches whether or not to use an intermediate image representing the image of the virtual object from a viewpoint of the camera when drawing the image of the virtual object, according to a state of a display world including the virtual object.

### Item 2

In the display image generation apparatus according to Item 1, in which, in generating the display image, the circuitry switches to drawing without using the intermediate image when the virtual object enters a predetermined range from another virtual object that is not allowed to be drawn using the intermediate image.

### Item 3

The display image generation apparatus according to Item 1, in which, in arranging the virtual object in the virtual three-dimensional space, the circuitry arranges, as the virtual object, a designation object by which the user designates a position in the display world, and in generating the display image, switches to drawing without using the intermediate image when the designation object designates another virtual object that is not allowed to be drawn using the intermediate image.

### Item 4

The display image generation apparatus according to Item 3, in which, in generating the display image, the circuitry switches to drawing without using the intermediate image when a virtual object using a template provided by middleware is designated as the other virtual object.

### Item 5

The display image generation apparatus according to Item 1, in which, in generating the display image, the circuitry represents, on a plane of the display image, the captured image projected onto a projection surface set in the virtual three-dimensional space and represents, on the plane of the display image, the intermediate image represented on the projection surface in a case where the image of the virtual object is drawn using the intermediate image.

### Item 6

The display image generation apparatus according to Item 1, in which the circuitry acquires data of the image captured by a camera provided in a head-mounted display, and outputs data of the display image to the head-mounted display.

### Item 7

An image display method including acquiring data of an image captured by a camera, arranging a virtual object to be operated by a user in a virtual three-dimensional space, generating a display image by drawing an image of the virtual object and synthesizing the image of the virtual object with the captured image, and outputting data of the display image, in which the generating the display image switches whether or not to use an intermediate image representing the image of the virtual object from a viewpoint of the camera when drawing the image of the virtual object, according to a state of a display world including the virtual object.

### Item 8

A recording medium that records a program for a computer, including, by a captured image acquisition section, acquiring data of an image captured by a camera, by an object arrangement section, arranging a virtual object to be operated by a user in a virtual three-dimensional space, by a display image generation section, generating a display image by drawing an image of the virtual object and synthesizing the image of the virtual object with the captured image, and by an output section, outputting data of the display image, in which the generating the display image switches whether or not to use an intermediate image representing the image of the virtual object from a viewpoint of the camera when drawing the image of the virtual object, according to a state of a display world including the virtual object.

1. An apparatus comprising:
one or more memory devices configured to store instructions; and
one or more processors, that upon execution of the instructions, are configured to:
acquire data of an image from a camera;
arrange a virtual object in a virtual three-dimensional space;
draw an image of the virtual object;
synthesize a display image from the image of the virtual object and the acquired image; and
provide data of the display image, wherein
the one or more processors are configured to determine whether to use an intermediate image while drawing the image of the virtual object according to a state of a three-dimensional space to be displayed including the virtual object, the intermediate image representing the virtual object from a viewpoint of the camera.

2. The apparatus according to claim 1, wherein
the one or more processors are configured to draw the image of the virtual object without using the intermediate image when the virtual object enters a predetermined range from another virtual object that is configured to be drawn without using the intermediate image.

3. The apparatus according to claim 1, wherein
the one or more processors are configured to arrange the virtual object at a position designated by a user in the three-dimensional space to be displayed, and
the processor is configured to draw the image of the virtual object without using the intermediate image when the virtual object is configured to be drawn without using the intermediate image.

4. The apparatus according to claim 3, wherein
the one or more processors are configured to draw the image of the virtual object without using the intermediate image when the virtual object is based on a template provided by middleware.

5. The apparatus according to claim 1, wherein
the one or more processors are configured to represent, on a plane of the display image, the acquired image projected onto a projection surface set in the virtual three-dimensional space and further configured to represent, on the plane of the display image, the intermediate image represented on the projection surface when the image of the virtual object is drawn using the intermediate image.

6. The apparatus according to claim 1, wherein
the one or more processors are configured to provide data of the display image to a head-mounted display (HMD) comprising the camera.

7. A method comprising:
acquiring data of an image from a camera;
arranging a virtual object in a virtual three-dimensional space;
drawing an image of the virtual object, comprising determining whether to use an intermediate image according to a state of a three-dimensional space to be displayed including the virtual object, wherein the intermediate image comprises the virtual object from a viewpoint of the camera;
synthesizing a display image from the image of the virtual object and the acquired image; and
providing data of the display image.

8. A non-transitory, computer-readable storage medium containing a computer program, which when executed by a computer, causes the computer to carry out actions, comprising:
acquiring data of an image from a camera;
arranging a virtual object in a virtual three-dimensional space;
drawing an image of the virtual object, comprising determining whether to use an intermediate image according to a state of a three-dimensional space to be displayed including the virtual object. wherein the intermediate image comprises the virtual object from a viewpoint of the camera;
synthesizing a display image from the image of the virtual object and the acquired image; and
providing data of the display image.

9. The method of claim 7, wherein drawing the image of the virtual object is executed without using the intermediate image when the virtual object enters a predetermined range from another virtual object that is configured to be drawn without using the intermediate image.

10. The method of claim 7, further comprising:
arranging the virtual object at a position designated by a user in the three-dimensional space to be displayed,
wherein drawing the image of the virtual object executed without using the intermediate image when the virtual object is configured to be drawn without using the intermediate image.

11. The method of claim 10, wherein
drawing the image of the virtual object is executed without using the intermediate image when the virtual object is based on a template provided by middleware.

12. The method of claim 7, further comprising:
representing on a plane of the display image, the acquired image projected onto a projection surface set in the virtual three-dimensional space; and
representing, on the plane of the display image, the intermediate image represented on the projection surface when the image of the virtual object is drawn using the intermediate image.

13. The method of claim 7, further comprising:
providing data of the display image to the HMD comprising the camera.

14. The non-transitory, computer-readable storage medium of claim 8, wherein drawing the image of the virtual object is executed without using the intermediate image when the virtual object enters a predetermined range from another virtual object that is configured to be drawn without using the intermediate image.

15. The non-transitory, computer-readable storage medium of claim 8, wherein the actions further comprise:
arranging the virtual object at a position designated by a user in the three-dimensional space to be displayed,
wherein drawing the image of the virtual object executed without using the intermediate image when the virtual object is configured to be drawn without using the intermediate image.

16. The non-transitory, computer-readable storage medium of claim 15, wherein drawing the image of the virtual object is executed without using the intermediate image when the virtual object is based on a template provided by middleware.

17. The non-transitory, computer-readable storage medium of claim 8, the actions further comprise:
representing on a plane of the display image, the acquired image projected onto a projection surface set in the virtual three-dimensional space; and
representing, on the plane of the display image, the intermediate image represented on the projection surface when the image of the virtual object is drawn using the intermediate image.

18. The non-transitory, computer-readable storage medium of claim 8, wherein the actions further comprise:
providing data of the display image to the HMD comprising the camera.
